(19) United States
(12) Patent Application Publication
(10) Pub. No.: US 2006/0198724 A1
(43) Pub. Date: Sep. 7, 2006

(54) Vertical axis turbine

(76) Inventor: Joseph Bertony, Hornsby North (AU)

Correspondence Address: ARENT FOX PLLC, 1050 CONNECTICUT AVENUE, N.W., SUITE 400, WASHINGTON, DC, 20036, US

(21) Appl. No.: 10/528,423

(22) PCT Filed: Sep. 20, 2002
(86) PCT No.: PCT/AU02/01295

§ 371 Date: Mar. 16, 2006

(30) Foreign Application Priority Data
Jan. 10, 2002 (AU) PR 9914

(51) Int. Cl. F03D 7/06

(52) U.S. Cl. 415/4.4

(57) ABSTRACT

A vertical axis turbine (1) with one or more stages. Each turbine stage has three longitudinally extending blades (5) each of which increases in axial cross-sectional width along the axis (2). The blades (5) are shaped to divert fluid flow and generate a rotation inducing torque. The fluid can be either wind or flowing water. The turbine (1) has a small footprint (surface area) and is normally used to generate electricity. Each blade (5) preferably has a vortex inducing edge strip (7).

### FIELD OF THE INVENTION

The present invention relates to turbines and, in particular, to turbines in which the axis of rotation is substantially perpendicular to the direction of fluid flow. The fluid can be either a gas, such as wind, or a liquid, such as water.

### BACKGROUND ART

Turbines are presently used as wind generators to generate electricity in an “ecologically friendly” manner. Typically such wind generators are horizontal axis devices bearing 2 or 3 propellers similar in appearance to aircraft propellers. The electric generator, gearbox and ancillary equipment are mounted in line with the propellers and turn with the wind. This requires expensive lifting equipment and expensive masts or towers. Consequently, these designs, whilst being commercially successful, are capital intensive. Furthermore, the “footprint” or effective surface area required for each wind generator is relatively large, because of the substantial diameter of the blades. In addition, horizontal axis wind generators must be braked at moderate wind speeds to prevent the tip speed of the blades exceeding the speed of sound. All these factors contribute to high maintenance and operational costs.

Vertical axis wind generators are known. This basic design enables the generator, gearbox and ancillary equipment to be placed at ground level. One design of a vertical axis turbine uses two thin curved blades and is referred to as an “egg beater”. The cross-section of such curved blades constitutes an aerofoil. In general, vertical axis wind turbines have not been commercially successful.

The object of the present invention is to provide a turbine which can be used as a vertical axis wind generator and thereby provide an alternative turbine.

### SUMMARY OF THE INVENTION

In accordance with the present invention there is described a turbine for rotation about a longitudinal axis substantially perpendical to the direction of fluid flow, said turbine comprising three longitudinally extending blades each of which increases in axial cross-sectional width along the axis, the leading surface of each said blade diverting fluid flow impinging thereon to generate a zone of reduced fluid pressure acting thereon and the trailing surface of each said blade having turbulent fluid flow impinging thereon to generate a zone of increased fluid pressure acting thereon.

### BRIEF DESCRIPTION OF THE DRAWINGS

Preferred embodiments of the present invention will now be described with reference to the drawings in which:

FIG. 1 is a perspective view of the turbine of a first embodiment vertically mounted for wind powered operation,

FIG. 2 is a horizontal cross-sectional view taken along the line II-II of FIG. 1,

FIG. 3 is a horizontal cross-sectional view taken along the line III-III of FIG. 1,

FIG. 4 is a side elevational view of the turbine of FIG. 1,

FIG. 5 is a sequence of views utilising FIGS. 2 and 3 and showing the rotational sequence,

FIG. 6 is a schematic plan view showing the preferred dimensional relationships for the first embodiment,

FIG. 7 is a side elevation showing the preferred dimensional relationships for the first embodiment,

FIG. 8 is a inverted plan view showing the preferred dimensional relationships for the first embodiment,

FIG. 9 is a plan view showing various preferred angular relationships for the first embodiment,

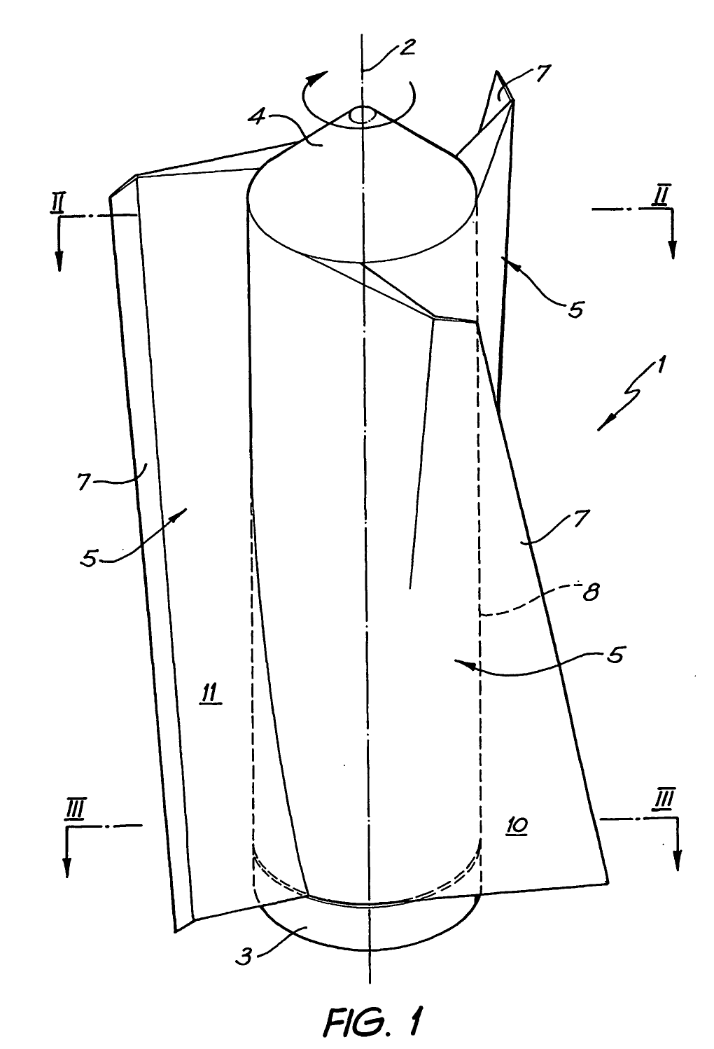

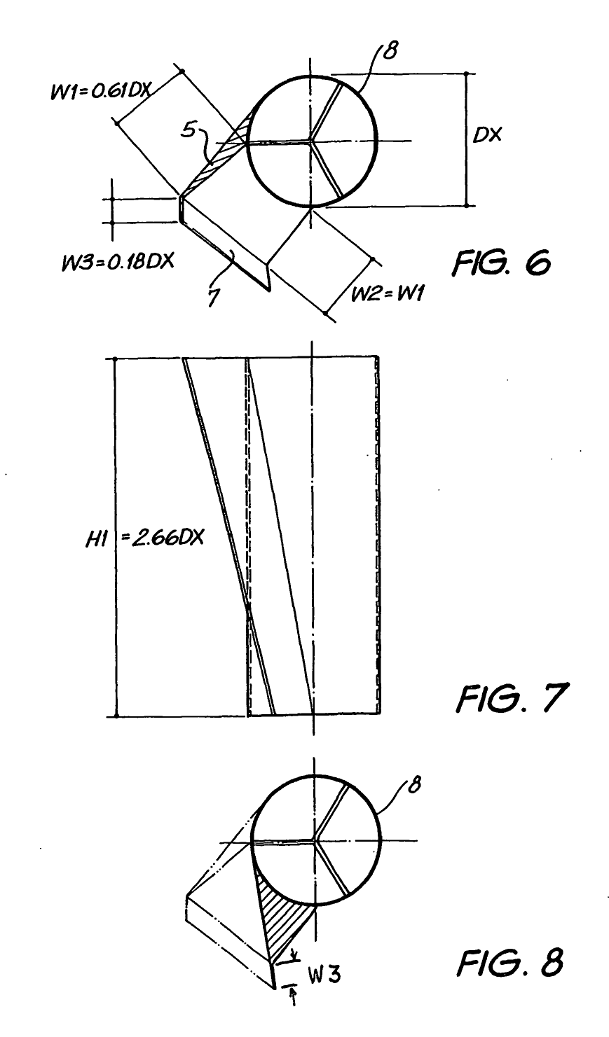

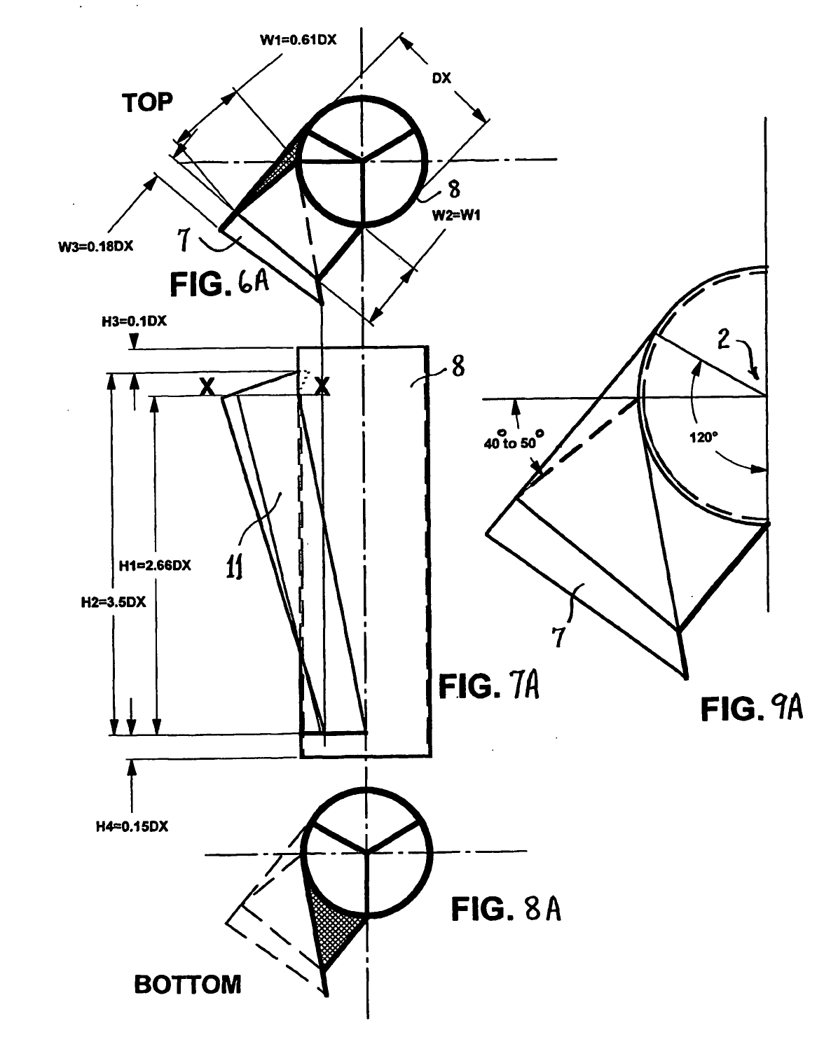

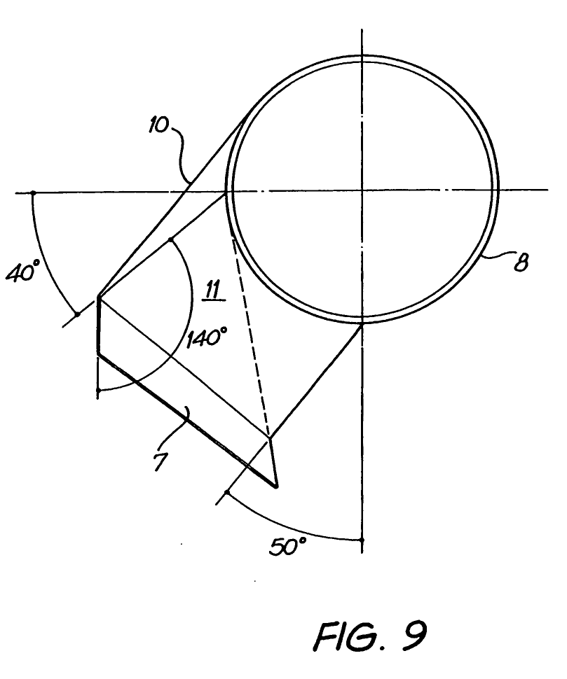

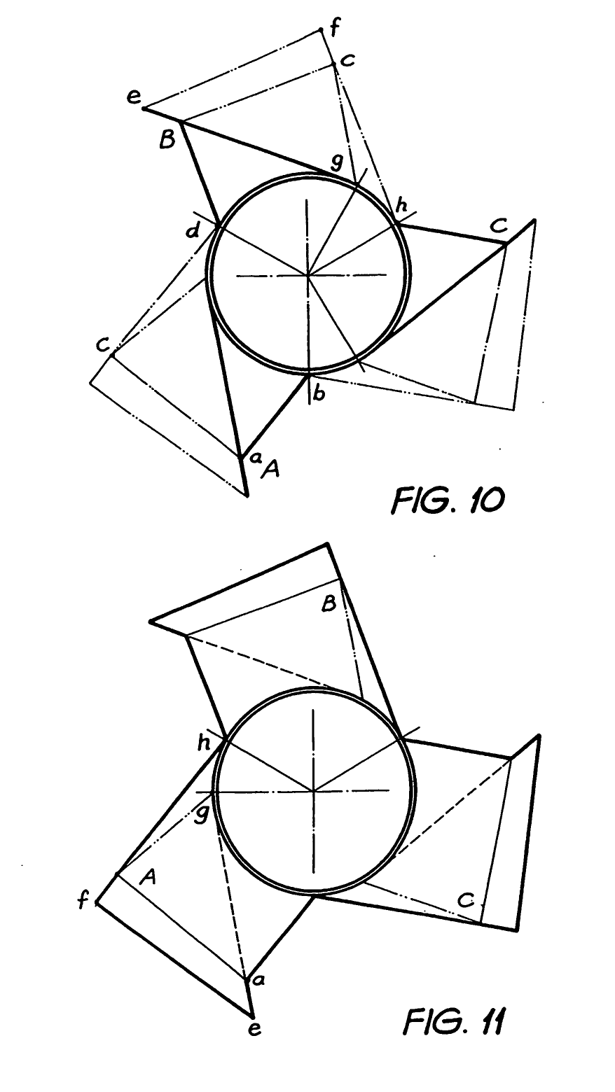

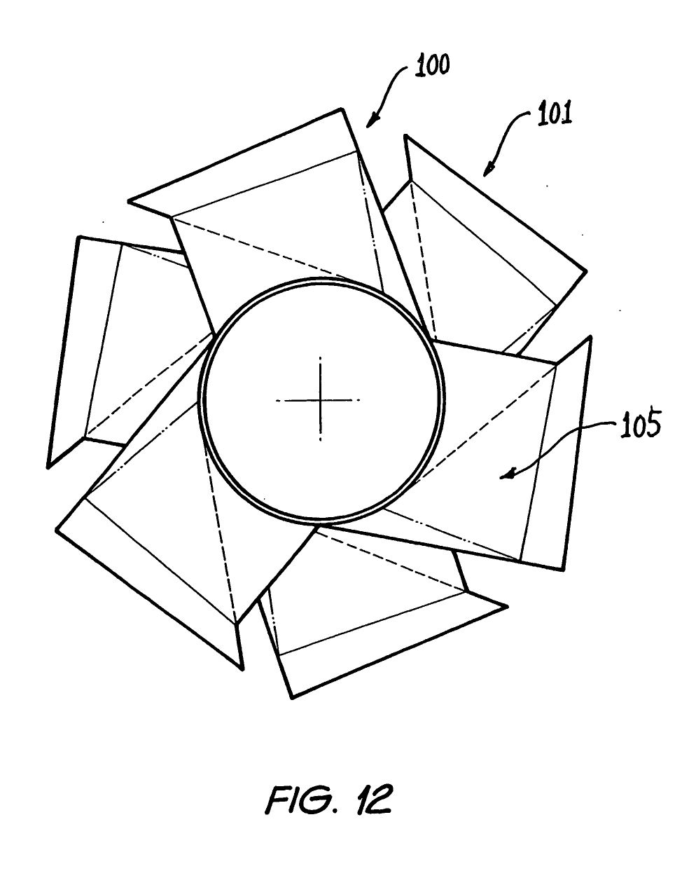

FIGS. 6A-9A are equivalent views to FIGS. 6-9 but illustrating the dimensional relationships for a second embodiment,

FIG. 10 is an inverted plan view of the second embodiment,

FIG. 11 is a plan view of the arrangement of FIG. 10,

FIG. 12 is a plan view of a pair of turbines mounted on a common axis and with relative radial displacement,

FIG. 13 is a side elevation of a pair of turbines mounted on a tower, and

FIG. 14 is a side elevation of a pair of water powered turbines.

### DETAILED DESCRIPTION

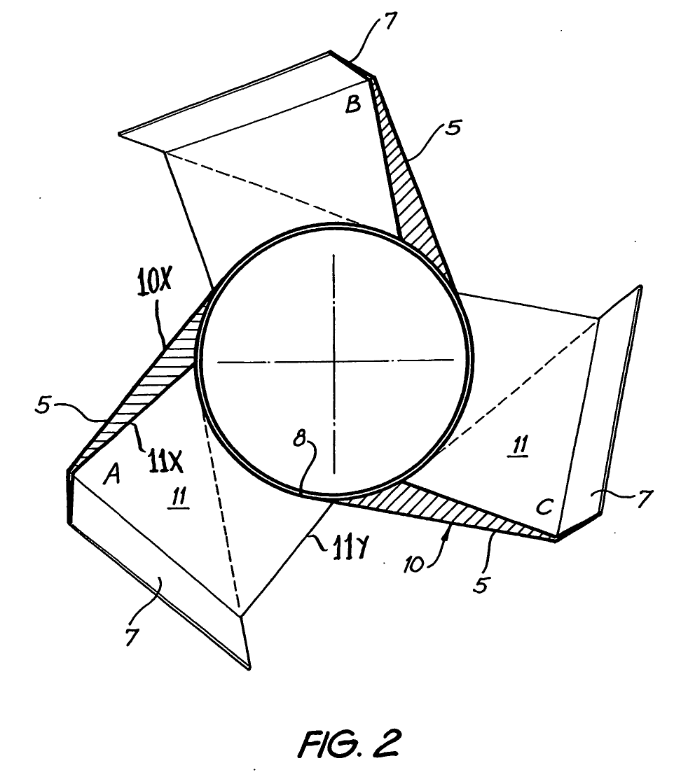

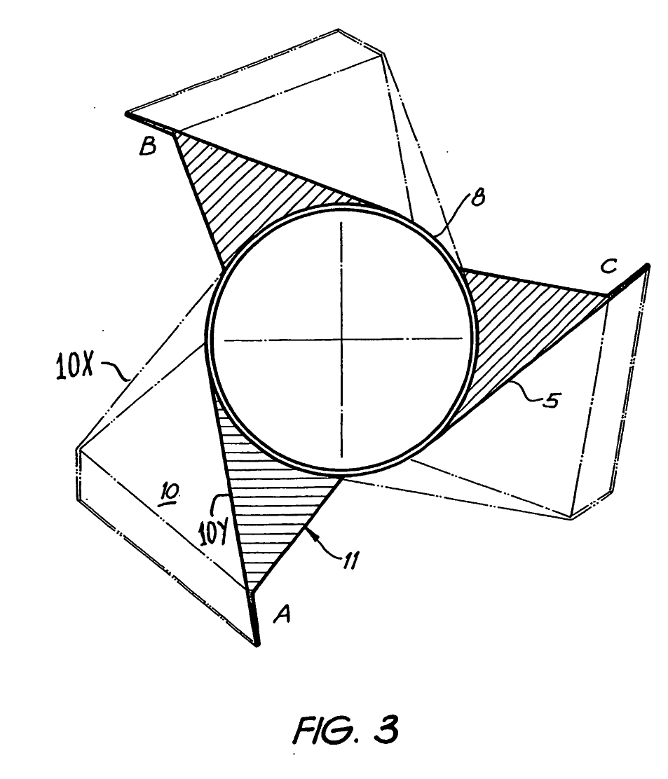

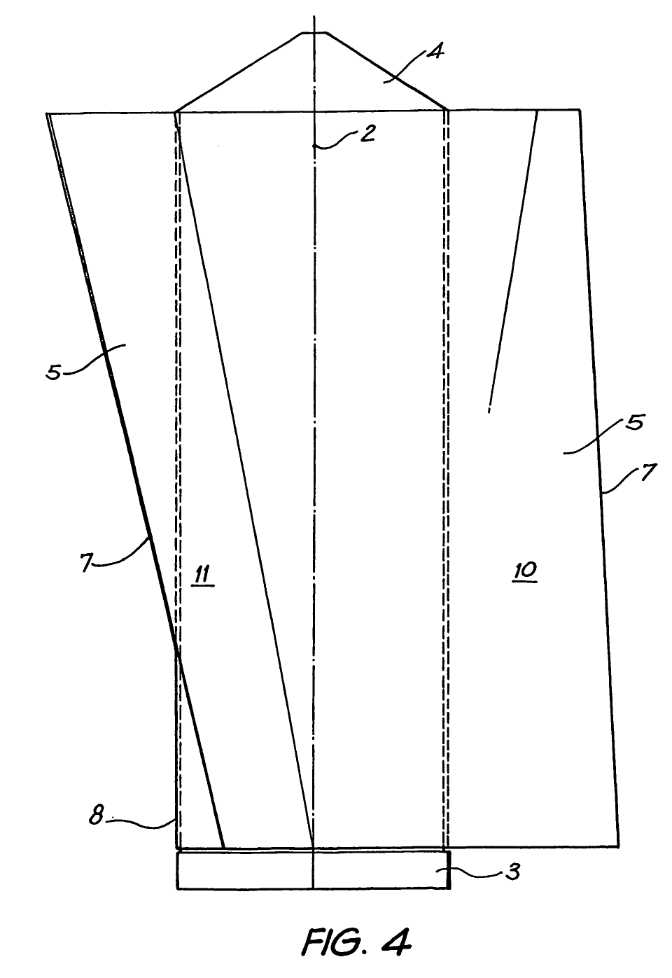

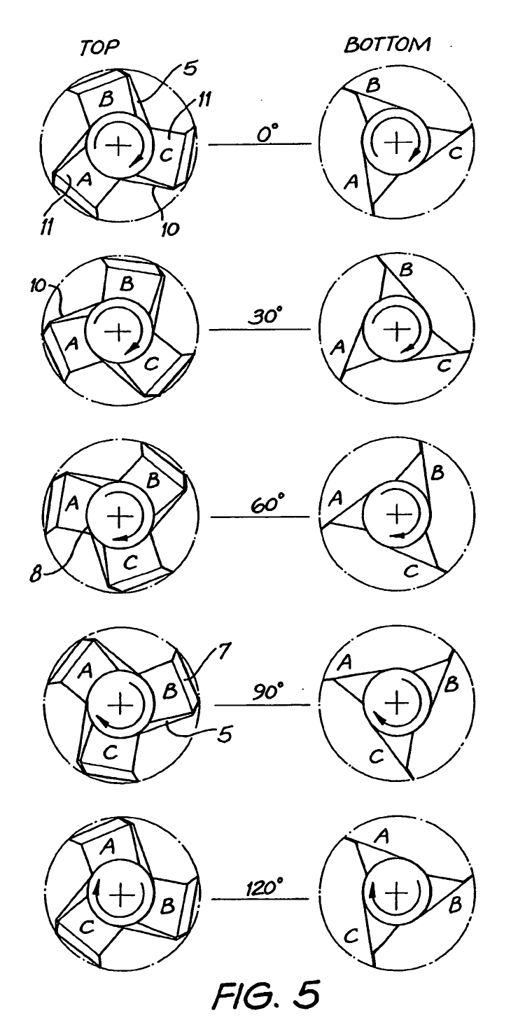

As seen in FIGS. 14, the turbine I is mounted about a substantially vertical axis 2 and is provided with a stationary base 3 and a conical cap 4 which rotates with the turbine 1. The turbine 1 has three identical blades 5 which, as best seen in FIGS. 2 and 3, are equally arranged at 120° to each other about the axis 2. Each blade 5 is provided with an edge strip 7 which extends from top to bottom of the blade 5 and has a substantially constant width.

The blades 5 are helically arranged with respect to the axis 2 and are swept rearwardly with respect to the intended clockwise direction of rotation (as seen in FIGS. 2, 3 and 5). The cross-sectional thickness of the blades 5 increases from top to bottom, however, in contrast the cross-sectional thickness of the edge strips 7 is substantially constant. The pitch of the blades is 90°.

As seen in FIG. 2 each blade 5 extends from a central drum 8 which is cylindrical and co-axial with the axis 2. When viewed in plan as seen in FIG. 2, the base of the edge strip 7 is tangential to the drum 8 as indicated by the dashed lines in FIG. 2.

As also seen in FIG. 2, the blade leading (with respect to the direction of rotation) surface 10 at the top of the blade 5 is tangential to the drum 8. Similarly, as seen in FIG. 3 the leading surface 10 is also tangential to the drum 8 at the bottom of the blade 5.

Each blade 5 also has a trailing surface 11. In FIG. 2 the upper and lower edges of the surface 11 are defined by two parallel lines 11X and 11Y respectively. In this embodiment, the surface 11 is a flat plane. The upper and lower ends of the edge strips 7 are kinked rearwardly relative to lines 11X and 11Y to the same extent. The increasing angle between the surfaces 10, 11 as one moves from top to bottom of the blade 5 is clearly apparent from FIGS. 2 and 3. This angle increases uniformly over the full blade length and results in a differential air flow velocity between the two surfaces 10, 11. The leading surface 10 smoothly interconnects its pair of generating lines 10X and 10Y and may be visualised as a helically curved plane.

The operation of the turbine will now be described by analogy to the operation of the sails of a yacht. With reference to FIG. 5 if it is assumed that the wind direction is from the top of the page towards the bottom, then at the 0° position blade C is catching or deflecting the wind in the manner of a main sail with the yacht sailing before the wind. That is, wind pressure develops on the trailing surface 11 of blade C. The blade C thus generates a torque to cause clockwise rotation.

In addition, the blade A is functioning as a jib or headsail. The wind is blowing over the curved leading blade surface 10 and so has a relatively low pressure acting on surface 10. This wind creates a vortex behind (or beyond) the edge strip 7. Therefore the air adjacent surface 11 of blade A is turbulent and thus has a relatively high pressure. Therefore there is a pressure difference across blade A and a clockwise rotation inducing torque is created.

Finally, for the 0° position indicated in FIG. 5, blade B is pointing substantially directly into the wind and thus generates little or no torque.

As the turbine turns to the 30° position illustrated in FIG. 5, blade B beings to function as a sail sailing before the wind, blade C begins to enter the lee caused by the drum 8, and the blade A continues to function as a headsail.

At the 60° position illustrated in FIG. 5, blades B and A are essentially functioning as for 30° but blade C is now fully in the lee caused by drum 8 and is thus not contributing any torque.

At the 90° position illustrated in FIG. 5, blade A's contribution is falling as it begins to point higher and higher into the wind, blade B's contribution is at or near a maximum, whilst blade C's contribution into the wind is only just commencing.

Finally, at the 120° position illustrated in FIG. 5, the same relationship to the wind as in 0° has been reached but with different blades. That is blade A has the same relationship to the wind as that formerly occupied by blade B, and so on. The generation of torque is thus analogous to that generated by a two stroke engine of three cylinders.

With reference to FIG. 5, it will be seen that unidirectional horizontal fluid flow impinging upon the relatively flat trailing surface 11 generates a clockwise driving torque over a wide angular displacement. In addition, it generates a generally upward turbulent flow. Further, it guides that flow onto, or towards, the following blade 5. Similarly, it will be seen that unidirectional horizontal fluid flow impinging upon the helically warped leading surface 10 generates a vortex at its radially outer edge and also generates a downwardly directed turbulent flow. These two generated flows result in a torque creating pressure being formed on the trailing surface 11.

Thus, these reactions to the incoming horizontal fluid flow result in a full rotation of the turbine with a substantially constant driving torque. The torque increases with increasing linear velocity of the fluid flow. The torque acts to increase the angular velocity of the turbine.

It will be apparent from FIG. 5, that the choice of wind direction is entirely arbtitrary. Thus the turbine generates torque irrespective of the wind direction. Whilst horizontal axis wind turbines must be turned to face the wind and thus are disadvantageous in conditions of rapid changes in wind direction as occur in light and “flukey” winds, vertical axis wind generators are not so disadvantaged, however.

FIGS. 6-9 provide the preferred relative dimensions of the turbine of the first embodiment expressed in terms of the drum diameter DX. Thus the apparatus can clearly be scaled to different sizes without difficulty.

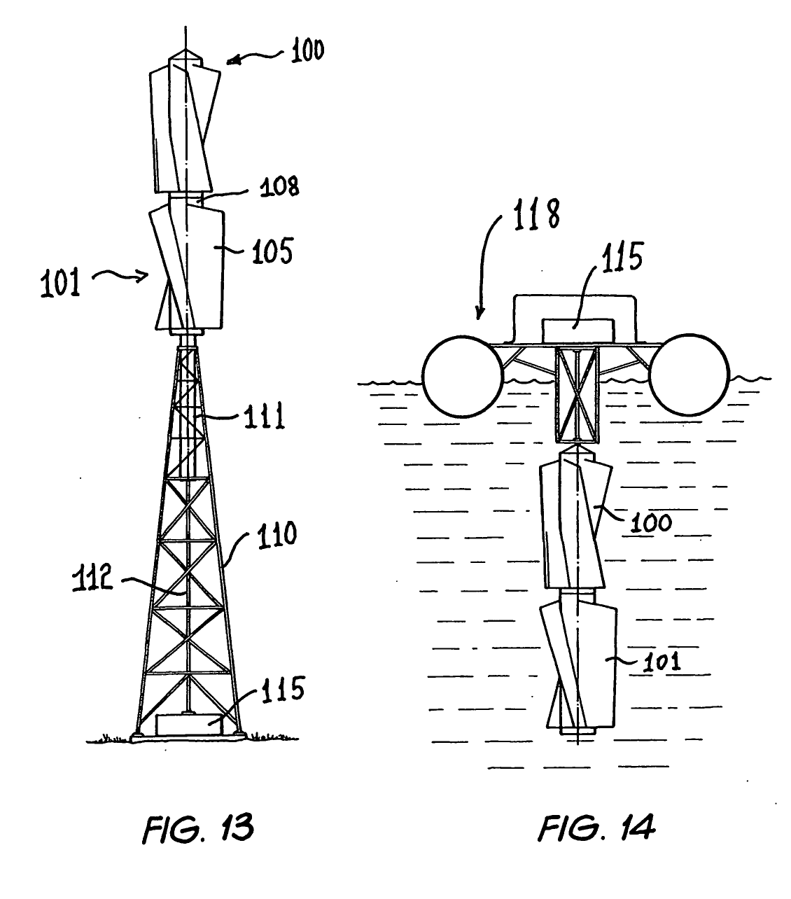

It will be seen that the foregoing arrangement results in a monolithic construction which rotates about the central vertical axis 2 of the drum 8. The trailing surface 11 is generally planar and is set with a vertical pitch. As indicated in FIG. 9, the radial set at the upper edge 10X of the leading surface 10 is approximately 40° whilst the radial set at the lower edge of the trailing surface 11 is approximately 50°. These two angles are relative to a normal extending from the cylindrical surface of the drum 8. In addition, the angle between the edge tip 7 and line 11X and line 11X as illustrated in FIG. 9 is preferably 140.

A second embodiment of a turbine in accordance with the present invention is illustrated in FIGS. 6A-9A which are views corresponding to FIGS. 6-9. It will be seen that the upper edge of the edge tip 7 is flush with the surface 10 in FIG. 6A, and not raked rearwardly as illustrated in FIG. 6. In addition, the height HI of the blade 5 is less than the overall length of the drum 8.

Turning now to FIGS. 10 and 11, these illustrate each of the three blades 5 of the second embodiment of FIGS. 6A-9A, in the manner of FIGS. 3 and 2 respectively.

It is preferred to mount two of the above described turbines 100, 101 on a common shaft with a radial displacement or offset of from 10 to 60 degrees. Different displacements suit different predominating fluid flow conditions.

As seen in plan in FIG. 12, the six blades 105 result in a smoother torque creation. Most important, however, is that the two turbines 100, 101 assist each other in that the downward flow from leading surface 10 of the upper turbine 100 is directed onto the leading surface 10 of the immediately trailing blade 105 of the lower turbine 101. This flow is in addition to the normal fluid flow onto that blade 105 and thus the total flow impinging upon the blade 105 is increased. The result of this effect is that the output of the two coupled turbines 100, 101 is approximately 2.5 times the output of a single such turbine 100 or 101.

As seen in FIG. 13, the preferred mounting and power transmission arrangement is a tower 110 having a stationary cylindrical hollow tube 111. The tube is fixed to the tower 110 and co-axial with the drum 108. The upper end of the tube 111 (not illustrated) carries a bearing for a hollow shaft 112 which extends through the tube 111. The lower end of the tube 111 also carries a bearing for the shaft 112. The lower end of the shaft 112 extends to ground level and drives an electric generator 115. The upper end of the shaft 112 (not illustrated) extends beyond the upper end of the tube 111 and is secured to the upper end of the drum 108. At the lower end of the drum 108, and interior thereof, are three wheels (not illustrated) which bear on the outer surface of the tube 111. These wheels provide a rotary support for the lower end of the drum 108.

Turning now to FIG. 14, a similar dual turbine arrangement to that of FIG. 13 is illustrated but arranged to be powered by water flow (for example, either river or tidal flow). The turbines 100, 101 are as before but are rotatably supported by a pontoon arrangement 118 which supports the generator 115.

### INDUSTRIAL APPLICATION

It will be apparent that the tower 110 occupies a much smaller area of land than conventional horizontal axis turbine because the overall maximum horizontal dimension of the turbines 100, 101 is much less than the diameter of the blades of a conventional horizontal axis turbine. Further, in general the maximum speed of the edge strips 7 will be less than the wind speed. Thus no expensive braking mechanisms are required as the sound barrier will not be exceeded.

The foregoing describes only some embodiments of the present invention and modifications, obvious to those skilled in the art can be made thereto without departing from the present invention. For example, although the illustrated embodiments are arranged to generate clockwise rotation, a mirror image thereof will generate anti-clockwise rotation. Similarly, the extension to three, four or more turbines mounted on a single shaft is readily apparent.

The term “comprising” (and its grammatical variations) as used herein is used in the inclusive sense of “including” or “having” and not in the exclusive sense of “consisting only of”.

1. A turbine for rotation about a longitudinal axis substantially perpendical to the direction of fluid flow, said turbine comprising three longitudinally extending blades each of which increases in axial cross-sectional width along the axis, the leading surface of each said blade diverting fluid flow impinging thereon to generate a zone of reduced fluid pressure acting thereon and the trailing surface of each said blade having turbulent fluid flow impinging thereon to generate a zone of increased fluid pressure acting thereon.

2. The turbine as claimed in claim 1, wherein each blade includes an edge strip rearwardly inclined relative to the direction of rotation.

3. The turbine as claimed in claim 1, and having the three blades arranged equally at substantially 120° about said axis.

4. The turbine as claimed in claim 1, wherein the pitch of said blades is from 90°-120°.

5. A plurality of turbines as claimed in claim 1, and mounted on said longitudinal axis.

6. The plurality of turbines as claimed in claim 5, wherein each successive turbine is radially displaced from its preceding turbine by a radial displacement relative to said longitudinal axis.

7. The plurality of turbines as claimed in claim 6, wherein said radial displacement is from 10 degrees to 60 degrees.

8. The turbine claimed in claim 7, and mounted for rotation by wind.

9. The turbine as claimed in claim 1, and mounted for rotation by liquid.

10. The turbine as claimed in any one of claim 1, and coupled to an electric generator.

11. A vertical axis wind turbine having three sails or blades set at substantially 120° spacing around a central vertical axis, each said sail having a leading surface and a trailing surface, said leading surface being shaped to provide forward impetus when wind flow impinges against same in a first direction, and said trailing surface being shaped to provide forward impetus when fluid flow impinges on same in a direction opposite to said first direction, wherein said three sails provide a substantially constant torque for substantially constant wind flow independent of wind direction.

12. The turbine as claimed in claim 11 wherein each said sail is provided with a longitudinally extending extension strip at the maximum radial extent of each said sail.

13. The turbine as claimed in claim 12 wherein each said extension strip is rearwardly inclined relative to the forward direction of rotation of the turbine.

14. The turbine as claimed in claim 13 wherein each said extension strip has a forward surface and a rearward surface which are substantially flush with the corresponding forward and rearward surfaces of the corresponding sail.
